(19) United States
(12) Patent Application Publication
(10) Pub. No.: US 2006/0168239 A1
(43) Pub. Date: Jul. 27, 2006

(54) Secure client/server data transmission system

(76) Inventor: Pierre Gauthier, Biot (FR)

Correspondence Address: JAMES C. LYDON, 100 DAINGERFIELD ROAD, SUITE 100, ALEXANDRIA, VA, 22314, US

(21) Appl. No.: 10/544,376

(22) PCT Filed: Mar. 12, 2004
(86) PCT No.: PCT/FR04/00613

§ 371 Date: Aug. 3, 2005

(30) Foreign Application Priority Data
Mar. 18, 2003 (FR) 03/03268

(51) Int. Cl. G06F 15/16

(52) U.S. Cl. 709/227; 709/203

(57) ABSTRACT

A system for transmitting data, including at least one data transmission network (10), one or several client machines (12, 14, 16) connected to the network and one or several server machines (18, 20, 22) which are also connected to the network and which can be connected at a given moment to one of the server machines in order to exchange data therewith. The system includes at least one central server (24) which is connected to the network. Each of the server machines have several connection devices enabling a permanent connection to be established with the central server, and each of the client machines have client connection devices enabling a provisional connection to be established with the central server.

The present invention relates to client/server environments in which connections are established by clients on servers via one or more transmission networks, principally networks based on TCP/IP protocol, whereby the present invention aims in particular to provide such a secure system by means of its design.

Today it is increasingly common for client computers to access data provided by servers via the Internet public network, private networks or a combination of the two. However, client/server architecture poses security problems due to the fact that it is possible to detect listening servers from afar and that it is possible for computer hackers to connect to them in order to take control of the hosts of these servers (by discovering passwords or by exploiting security loopholes) or in order to disable these servers (denial of service attacks).

Denial of service attacks (DoS) render servers inaccessible by swamping them with a large number of connections in order to prevent the servers from responding to legitimate users. In the case of distributed denial of service attacks (DDoS), thousands of previously compromised machines are used to collectively assault a server. New variants use third-party servers or routers as mirrors to increase the effect of the attacks while remaining totally anonymous. Recent events show that these malicious acts are becoming increasingly prevalent and that no-one is safe from them.

It is therefore very important to make all machines connected to the Internet (including those belonging to the general public) secure in order to avoid them being used to attack servers.

In order to make servers secure, consideration has been given to using longer and more complex passwords and to filtering the IP addresses accepted, and various devices such as firewalls are installed at great expense to act as a barrier in front of each server in order to limit attacks. Unfortunately, due to the fact that it is possible to wrongfully assume an identity, these measures do not offer protection from brute-force password attacks, from exploitation of security loopholes in the server or the operating system, or from denial of service attacks. Furthermore, the installation of effective firewalls presents several problems beyond the cost of acquiring and maintaining them. In effect firewalls must be configured to permit external users to reach protected machines. This obligation gives rise to technical, legal and logistical problems, and is expensive in terms of time and use of qualified personnel and entails manipulation which comprises the risk of errors which can lead to breakdowns or breaches of security. There are solutions involving passage through firewalls but the use of these remains very restricted due to the large amount of infrastructure which has to be installed to make use of them. Furthermore, their embodiment calls for components which are badly adapted, are obsolete, do not perform well and are also dangerous from the point of view of safety.

The costs incurred due to the introduction of security measures increase as the number of servers deployed to render a given service increases. In the case of user assistance or remote maintenance of machines, it is necessary to have a server on each machine. This amounts to millions of servers which can be discovered by a hacker using a port scanner to discover listening servers or by a virus or a worm making use of known security loopholes in order to infiltrate from machine to machine on the network.

All server types are vulnerable (Web servers, email, inventory systems, online databases, user help applications, maintenance applications, etc.) and even each workstation (due to the fact that services await connections there) and businesses and administrative bodies all over the world can no longer do without these tools today.

It is for this reason that the aim of the invention is to provide a secure client/server data transmission system in which the servers which have become clients no longer accept any incoming connection, which prevents all computer attacks such as denial of service.

Another aim of the invention is to achieve a method of transmission via a data network in which the establishment of a connection of a client to a server is carried out via a single central server capable of receiving connection requests.

The object of the invention is therefore a Data Transmission System, including at least one data transmission network, one or more client machines linked to the network and one or more server machines which are also linked to the network, whereby each of the client machines is able to be connected at a given moment to one or more of the server machines in order to exchange data with it (each of the server machines being able to receive several connections at the same time). The system includes a central server linked to the network, with each of the server machines including server connection means which permit the establishment of a permanent connection to the central server and each of the client machines including client connection means which permit the establishment of a temporary connection to the central server when the client machine wishes to be connected with a particular server machine to exchange data, whereby the central server includes central server connection means allowing the temporary connection to be linked to the permanent connection so as to establish the connection between the client machine and the server machine.

The aims, objects and characteristics of the invention will become more clearly apparent on reading the following description with reference to the drawings, in which:

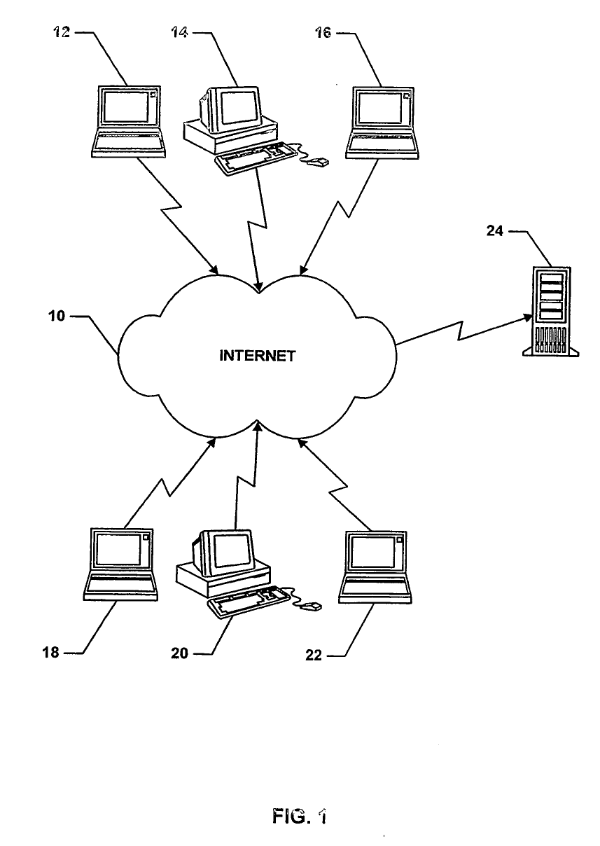

FIG. 1 is a schematic representation of a data transmission system according to the invention,

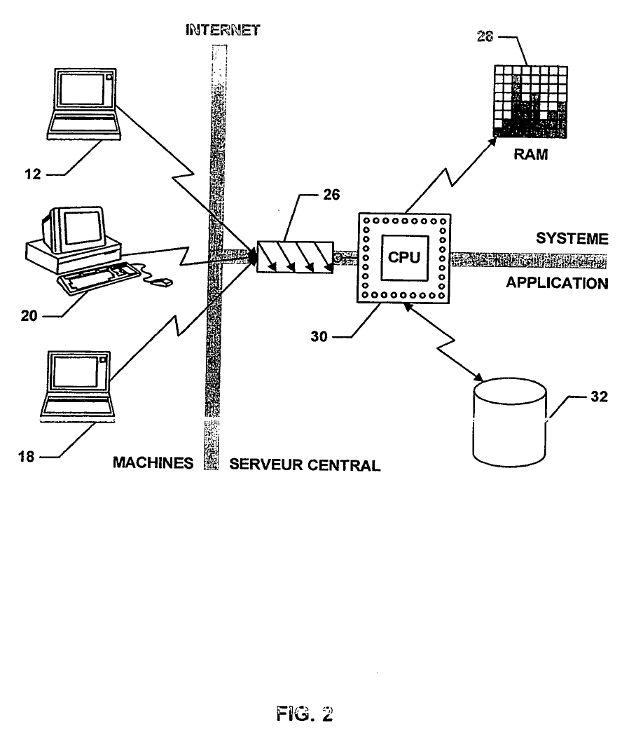

FIG. 2 is a block diagram which schematically illustrates client and server machines connected to the central server which is divided into its different components,

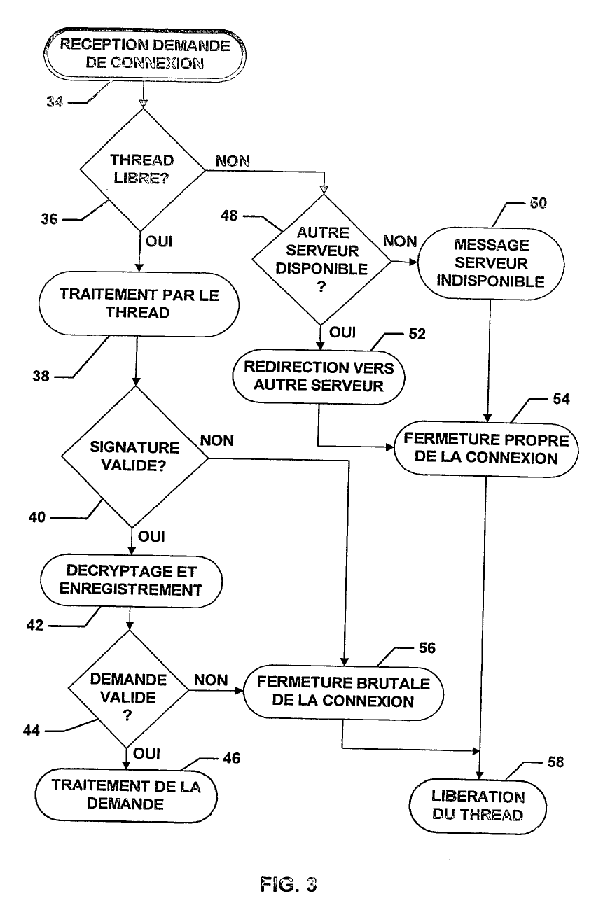

FIG. 3 is a flow chart of the method implemented in the central server in order to establish a new connection,

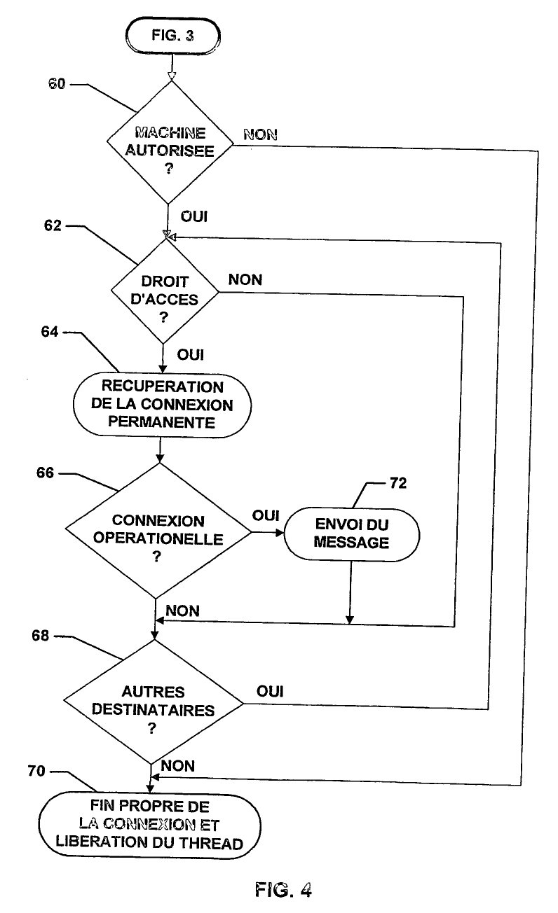

FIG. 4 is a flow chart of the method implemented in the central server to send a message from a client or server machine to one or more client or server machines,

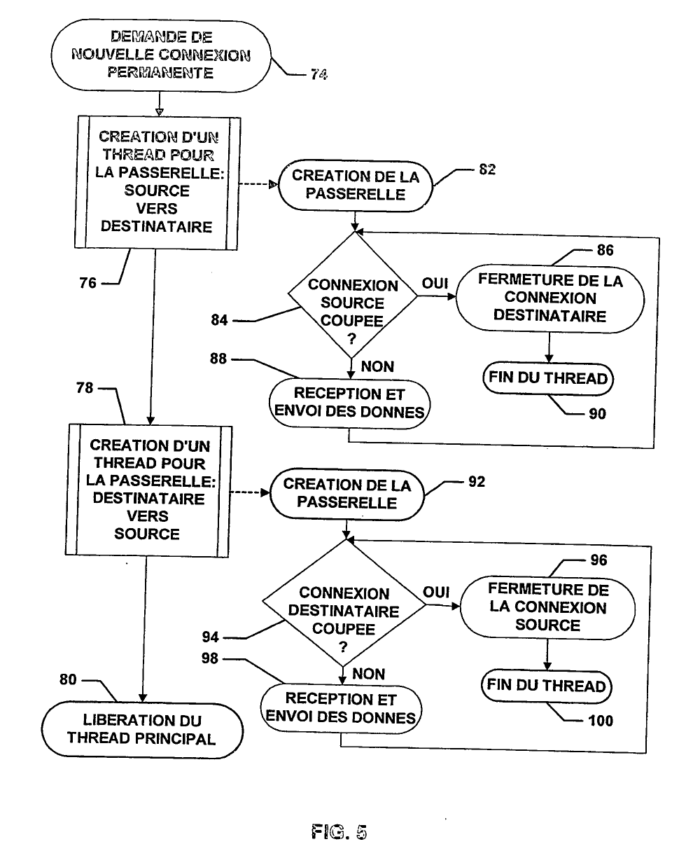

FIG. 5 is a flow chart of the method implemented in the central server in order to establish a bidirectional bridge,

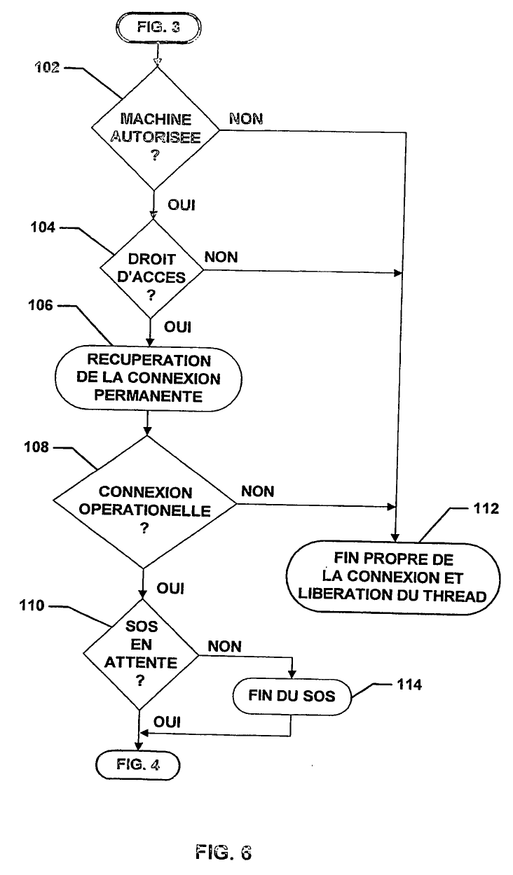

FIG. 6 is a flow chart of the method implemented in the central server in order to establish a remote control or file transfer interactive session between a client machine and a server machine,

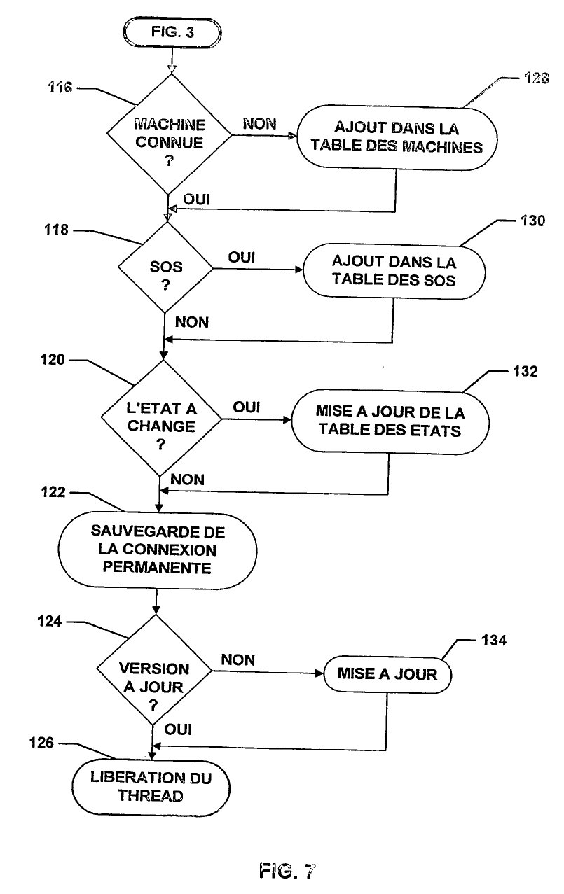

FIG. 7 is a flow chart of the method implemented in the central server to record a change of status submitted by a client machine or server machine, and

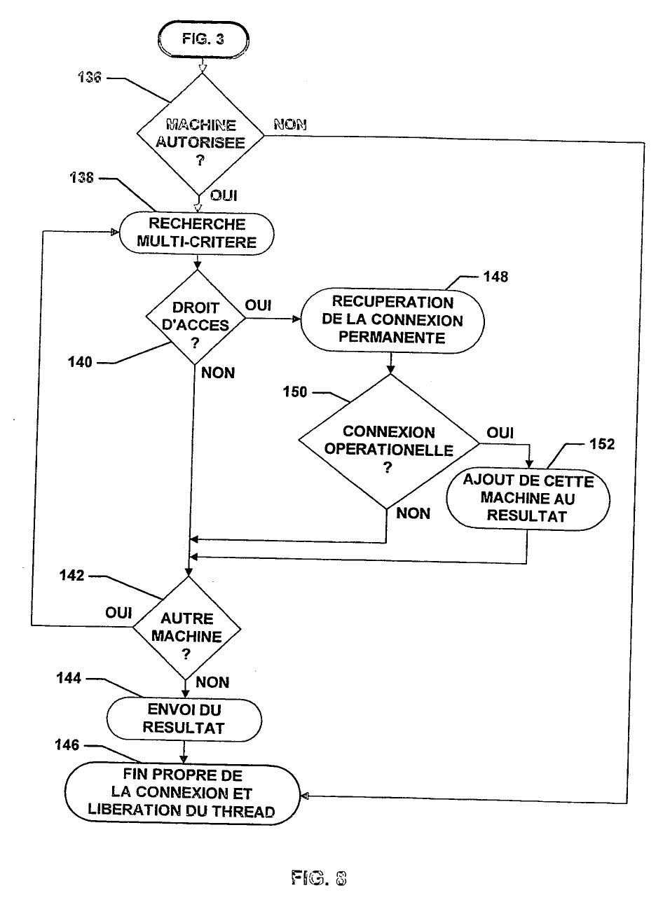

FIG. 8 is a flow chart of the method implemented in the central server to process a search request initiated by a client machine for the server machines available on the network.

A data transmission system according to the invention illustrated in FIG. 1 is constructed around a data transmission network such as the Internet network 10. Connected to this network are, on the one hand, client machines or computers 12, 14, 16 and, on the other hand, servers or server machines 18, 20, 22. As illustrated by the network attachment arrows, the connections are always outgoing, i.e. created at the behest of the client or server machines. The connections all have as their destination a central server 24 which is designed to link a client machine with a server machine by establishing a bidirectional bridge between the connections established by each of the two machines. It should be noted that there could be several central servers sharing the total load.

In order to establish the connections, each client machine has connection software of approximately 650 KB and each server machine has software of approximately 80 KB, with these two files being able to be used at the same time on the same machine. It should be noted that these files result from the adaptation of an existing client/server application for remotely-controlling PC's to the device according to the invention. For its part, the central server has connection software in the form, for example, of an executable file of approximately 650 KB which is written in C++ language.

It should be noted that, according to a preferred embodiment of the invention, the software of a server machine or a client machine establishes a permanent connection and initialises the automatic recording of this machine at the central server as soon as the server machine connects to the Internet network. If a server machine does not have permanent access to the Internet network, a non-permanent link is established upon request when an SOS call is sent by the user of the server machine as described hereafter.

The central server and the client machines (together or separately) can contribute, in a centralised or distributed manner, to the formation (and/or maintenance) of persistent lists of objects of any kind (clients, users, access authorisations, privileges, connections, data obtained by clients or to be sent by clients), of their characteristics (status, system identifier and properties) as well as of their derivatives, with all or part of this information in addition not requiring to be kept and being able to be used only at the moment at which it is needed. Clients can periodically send a packet to the central server (“keep alive”) in order to detect connection breaks and to re-establish a connection as soon as possible.

The machine access authorisations are centralised in a database which is maintained by the central server in order to retain the list of machines and users, the history of operations and all other useful information. They allow rights to be defined by detailing the functions available per user on each machine knowing that a client machine may only be used by an authorised user and only if this client machine has also been previously authorised in the database of the central server. As all of the connections pass via the central server, it is impossible to bypass the access right controls.

As already mentioned, client and server machines such as machines 12 to 22 illustrated in FIG. 2 automatically register, when the machine starts up or at the behest of the user, in the database 32 of the central server. If the correct electronic signature scheme, the correct private key, the correct encryption algorithm and the appropriate syntax are used, the connection of the machine to the network interface 26 of the central server is achieved after it is validated and authenticated by the processing unit 30 of the central server. The central server then allows the operating system to maintain the inactive connections in a permanent manner in RAM 28 until the central server requires one of these connections.

Each new permanent connection which reaches the central server replaces the inactive connection of the machine in question and the system identifier of the new connection is saved in the database 32 of the central server. In the case of temporary connections, the new connection is closed properly or suddenly in accordance with the thinking described hereafter. In the event of a “proper” closure, the remote machine is warned of the termination of the connection whereas, in the event of a “sudden” closure, the central server takes no precautions.

The RAM memory 28 as well as, generally, the resources of the central server are recycled because in the case of a permanent unexpected connection break with a client or server machine, the connection left open at the central server will be closed again when a new permanent connection to the central server is re-established by this machine.

With reference to FIG. 3, a connection request starts at the central server with the receipt of a connection coming from a client or server machine (step 34). The central server determines whether a thread remains free amongst the group of threads created by the central server to process incoming connections (step 36). In the present description a “thread” means an “autonomous executing unit”. If there is no free thread, it is necessary to determine whether another central server is capable of processing the request (step 48), transmit the request to this other central server (step 52) and to properly close the connection (step 54) before the thread is freed (step 58). If there is no other central server, a message indicating that the server is unavailable is transmitted to the machine (step 50) and the connection is properly closed (step 54) before the thread is freed (step 58).

When the central server has a free thread, the request is processed by the thread (step 38) and the validity of the signature and the other security measures is verified (step 40). If a negative result emerges from the verification, the connection is cut by means of sudden closure and the request is recorded (step 56) before the thread is freed (step 58). Otherwise, the request is decrypted and recorded (step 42). The central server then verifies whether the request is valid, i.e. if the syntax of the command is correct (step 44). If it is correct, the request is processed (step 46) differently according to whether it relates to a change in status, a search, an online discussion, remote control or a file transfer, as will be seen hereafter. Otherwise, the connection is suddenly cut and recorded before the thread is freed (step 58).

The establishment of a connection to the central server used in order to transmit data to one or more recipient machines makes it necessary to create one or more broadcast means such as unidirectional links used to transmit information to one or more server machines. An example which illustrates this case is described below relating to an online discussion between two parties or in conference mode involving more than two parties (Chat).

The method for establishing an online discussion (Chat) between a client machine and one or more server machines shall now be described with reference to FIG. 8. It should be noted that a new connection has already been established between a client machine and the central server as previously described with reference to FIG. 3. The central server firstly verifies in its database if the client machine is authorised to communicate with the central server (step 60). If it is not, the central server properly terminates the connection (step 70) and frees the thread used for the connection in FIG. 3.

The central server then verifies in its database, for each of the server machines requested, whether the user of the client machine has the necessary rights to be linked to the requested server machines (step 62) and whether the permanent connection between the central server and the requested machine is still operational: the permanent connection is retrieved from the database (step 64) and verified (step 66). If these conditions are not met, the central server passes to the next recipient machine and properly terminates the connection if there are no more recipients for the message. If the connection is operational and the rights are valid, the central server sends the message received from the client machine to all of the server machines which are accessible according to the rights and of which the permanent connection is operational (step 72). Note: the central server can possibly send a message before closing the connection in order to inform the client who sent the message that a certain correspondent was not available or was not authorised to be contacted. Finally, after sending the message, the central server properly terminates the connection (step 70) and frees the thread.

When the request emanating from the client machine relates to the establishment of an interactive communication between this client machine and a server machine, the interconnection achieved in the central server is brought about in the manner illustrated in FIG. 5.

Firstly, the central server transmits an order to the recipient server machine in order to request it to establish a new permanent connection to replace the existing permanent connection which is going to be used (step 74). A bidirectional bridge is then created by the central server in such a way that the link is established between the new connection of the client machine which made the request and the former permanent connection of the recipient server machine. A bridge of this type is brought about in two stages. In order to operate the bidirectional bridge, a thread is firstly created (step 76) to manage a unidirectional gateway, with the aim of transferring the data coming from the source connection, i.e. the connection emanating from the machine which has made the request, to the recipient connection, i.e. the connection of the requested machine. Another thread is then created to manage a second unidirectional gateway with the aim of transferring the data coming from the recipient connection to the source connection (step 78).

The main thread used for the connection in FIG. 3 and which has created the two threads of the bidirectional bridge is then freed (step 80). If one of the two connections is cut (steps 84 or 94), the other connection is closed properly (steps 86 or 96) which terminates the bidirectional bridge process by the destruction in a cascading manner of the two threads of the unidirectional gateways (steps 90 or 100). When a unidirectional gateway receives data from one of the connections, it transmits it to the other connection (steps 88 or 98) which maintains a bidirectional bridge between the two machines connected to the central server.

The establishment of a bidirectional bridge by the central server as described previously takes place when it is necessary to create a bidirectional link of any kind between a client machine and a server machine and in particular in the case where the server machine is remotely controlled by the client machine, with the client machine interacting in real time with the screen of the server machine reproduced on the screen of the client machine, or in the case of a file transfer between the two machines. It should be noted that a unidirectional alternative of this bridge consists simply of creating a single gateway thread on the two created in the bidirectional case which can be useful when the message to be sent is too long or is sent over a period which is too long to implement the previously described procedure for online discussion (Chat).

The procedure implemented for remote control or file transfer is described with reference to FIG. 6. A new connection to the central server has already been established previously by the client machine as described with reference to FIG. 3. The central server firstly verifies in its database whether the client machine is authorised to communicate with the central server (step 102). If it is not, the central server properly terminates the connection (step 112) before freeing the thread used for the connection in FIG. 3. If access is authorised, the central server verifies in its database whether the user of the client machine has the necessary rights to be linked to the recipient server machine (step 104). If this is not the case, the central server can transmit an “access refused” message to the client machine and then properly terminates the connection (step 112) before freeing the thread. If the client machine and the client user have the required rights, the central server retrieves in its database the system identifier of the inactive permanent connection of the recipient server machine (step 106).

Before establishing the link between the two machines, the central server verifies if the permanent connection between the server machine and the central server is still operational (step 108). If this is not the case, the central server can transmit a “resource unavailable” message to the client machine and then properly terminates the connection. If the connection is still operational, the central server verifies if an SOS, i.e. a request for help required by the user of the recipient server machine, is awaiting a response (step 110). If this is the case, the central server signals the termination of the SOS to the client machines which have an operational permanent connection and the right to access this server machine and updates the SOS table in its database (step 114). When these operations have been carried out or if there is no waiting SOS, the link can be established by creating a bidirectional bridge such as described with reference to FIG. 4.

Apart from the links established between a client machine and a server machine by the central server, the central server must, in order to allow a client machine to locate a server machine and vice-versa, process other connection requests notably relating to registration or to the change of status of a machine and to the search for a machine which is available according to one or more criteria.

It is in effect the only way to join one machine to another since the very principle of the device according to the invention no longer uses network addresses to join a machine because the addresses of the machines which can be joined by the central server are not unique: the machines of a same private network share the same public address of their connection point to the public network and their private address has every chance of being used on another private network. For these reasons, the central server must imperatively keep a real-time list of the available machines and (possibly) the available users in order to allow the machines to consult this list before communicating amongst themselves. The only link which allows a machine to be joined from the central server is, of course, the permanent connection but the search can be carried out on the machine or user names or even on the MAC (Media Access Control) addresses if the central server's database puts this information into correspondence.

The procedure used to register or change the status of a client or server machine is described with reference to FIG. 7. It is assumed firstly that a new connection has been established by the machine which identifies itself to the central server as previously described with reference to FIG. 3. The central server starts by verifying if the machine which identifies itself is already known (step 116). If this is not the case, the central server saves the new connection by adding the system identifier into a table of machines in its database (step 128). If the machine is already known, the central server verifies if the request corresponds to an SOS emanating from a server machine (step 118). If this is the case, the SOS is recorded in the SOS table located in the database of the central server and is transmitted to all of the client machines which are online and which have the right to access this server machine (step 130). After these operations or if there is not an SOS, the central server verifies if the status of the machine identifying itself and of its user are the same in the database of the central server (step 120). If this is not the case, the status (machine address, new user, screen saver, online status, memory levels, operating system type and version, etc.) is recorded in the table of statuses located in the database of the central server (step 132). The central server then closes the former permanent connection of this machine, if it was valid, and saves the system identifier of the new permanent connection in its database (step 122). The central server then verifies if the version of the application of the machine which identifies itself is older than the version available on the central server (step 124). If this is the case, the central server automatically updates the application (step 134) on the machine which identifies itself, then the central server frees the thread (step 126) used for the connection in FIG. 3.

The method used for a search is now described with reference to FIG. 8. It is understood that a new connection has been established between a client machine and the central server as previously described with reference to FIG. 3. The central server firstly verifies in its database if the client machine is authorised to communicate with the central server (step 136). If this is not the case, the central server can transmit an “access refused” message to the client machine and then properly terminates the connection (step 146) before freeing the thread used for the connection in FIG. 3. If access is authorised, the central server searches in its database for machines meeting the set criteria (step 138) and it verifies, for each machine found, whether the user of the client machine which sent the request has the rights required to access the server machine (step 140) and then it retrieves the permanent connection of each of the machines from its database (step 148) before verifying that this is indeed operational (step 150). If this is not the case, the central server can possibly transmit an “access refused” or “machine unavailable” message to the client machine and, if there are no more machines corresponding to the search, it then properly terminates the connection before freeing the thread (step 146). If the rights permit access and if the connection is operational, the central server creates a list of machines found during the search and sends this list to the client machine (step 144) at the end of the search. Finally, the central server properly terminates the connection (step 146) before freeing the thread.

The present invention can be implemented in all network architectures comprising a plurality of servers. It can be used with TCP/IP protocol or any other connection oriented protocol, such as, for example: Sequence Packet Exchange (SPX) from Novell, System Network Architecture (SNA) from IBM, Open Systems Interconnection OSI/X25 Connection Oriented Networking Service (CONS), Xerox Network System (XNS) from Xerox, DECnet, AppleTalk, Banyan Vines. It can thus be implemented in the following examples:

1. Help Desk Client/Server System.

In this type of application which enjoys widespread use in businesses, it is necessary to install server applications on all machines which are to be managed remotely. In contrast to conventional client/server applications, the system according to the invention is capable of reaching machines located on private networks without configuring routers or firewalls and allows completely secure deployment because the client and server machines are invisible and cannot be attacked. The system according to the invention is radically different, in terms of the means employed and its mode of operation, from existing solutions for passing through firewalls consisting of a Web server using a Java server in CGI (Common Gateway Interface), Java applets at the client side, and an SQL server because the central server is a server application in the form of a single block which is able to operate in a completely autonomous manner. It is much safer because it is not made up of components which have not been designed to perform tasks which set high demands in terms of security and performance. It is also much quicker due to the fact that the connection software of the client machines, server machines and central server is written in optimised portable C++ and the latency times are reduced as much as possible because the central server alone acts as a Web server, a Java application server and an SQL server which eliminates the latency times generated by the processing of the data by each of these components, the latency time induced by the necessary translation of the data between the components and the latency times created by the network transmission of the data between each of these different components. Furthermore, the system according to the invention is independent of HTTP protocol because the central server does not use this protocol and therefore does not pose the performance and security problems which are inherent in this protocol. The unique method of managing the connections described previously also allows uninterrupted access to any server machine, even if it is already connected to a client machine. Finally, this system is considerably easier and less expensive to install and to maintain than any other existing Help Desk solution, irrespective of whether it uses passage through a router and firewall, due to the fact that the recording of the users and the machines in the database is carried out automatically, no security measure or network configuration measure is necessary and the solution may be deployed when desired due to the small size of the server part (80 KB).

It should be noted that in this example the clients also behave as servers and the servers behave as clients because an online discussion (Chat) can be initiated from both sides, irrespective of whether it is a client or a server which is installed on a machine. In the same way, file transfer could in this case be initiated from a server.

2. DRM (Device Relationship Management) Client/Server System

DRM allows companies, manufacturers, and service firms to monitor, manage and maintain, in real-time, intelligent apparatuses—such as: photocopiers, lifts, production lines, automated cash dispensers, cash registers, weather stations, petrol pumps, medical equipment or fleets of aeroplanes, lorries or boats—deployed at distant sites throughout the world. The intelligent agents deployed are not awaiting connections, which protects them from remote detection and allows attacks to be avoided.

The DRM central server comprises, in addition to the normal functionalities of the central server, the “transparent tunnel” function for any type of application, either software or hardware, which requires to transfer data on distributed networks such as the Internet in a safe manner and in real time. This transparent tunnel function is implemented at the agent side (whereby an “agent” can be both a client and a server) and at the DRM server side in order to allow a third apparatus or software to use the agent to join other agents or in order to request or send data to the DRM server and vice versa which permits a management strategy, which is adapted to each type of intelligent apparatus, to be implemented with filters, alerts, business rules, and data to be provided to these apparatuses or coming from these apparatuses.

The DRM server is also useful for companies which edit network software: network programming is simplified to the maximum extent (all that remains necessary is to specify a recipient by name wherever it is in the world in order to send data to it or request data from it). In this case, the only parts which still require to be created are the part in contact with the DRM agent and the part in contact with the DRM server—i.e. the defining essence of the application itself (automaton control, data acquisition, maintenance, accounting, management of a point of sale system, etc.).

Furthermore, the writing of new network applications using the DRM leads to immediately ensured security (it will no longer be necessary to verify each line of code of new products in order to search them for security loopholes because these loopholes, even if they exist, can no longer be exploited).

The DRM server is considerably easier to use and less expensive to install and to maintain than any other existing solution due to the fact that it resolves by itself all technical difficulties related to access to networks and to security problems inherent to this access.

According to the inventor, the advantages of the DRM server are so obvious that no organisation could ultimately do without an equivalent solution. Due to the minor nature of the modifications to be carried out to the solutions already in place, it is possible to enact a progressive migration allowing a mixed operation keeping the conventional approach while favouring the installation of the technology of the central server in the most important priority applications (this approach having been successfully tested in the Help Desk application presented in Example 1).

3. Private Network Protection Client/Server System

Traditional gateways (bridge, router, firewall, proxy, etc.) permit the transmission of network traffic of two networks or more due to the fact that the gateway straddles these networks, having a network interface in each of the networks for which it redirects traffic.

Instead of this, the central server uses only one single and unique network interface to transmit traffic from an infinite number of source networks to an infinite number of destination networks, regardless of the geographical situation of the central server with respect to the topology of the networks for which the central server redirects traffic.

The implementation of a system according to the invention permits, using the technology of the central server for a gateway (router, firewall, proxy etc.), the decentralisation of the network security currently distributed on a single and unique central server.

It is sufficient for the agent part (client or server) of the invention to deal with all of the possible connections on all of the client and server machines. The two client and server components can furthermore only be formed as a single unit or be installed together on each machine. Thus there is no longer any workstation or server listening for any service: instead of this, the central server manages all requirements by means of distributed agents which are completely safe due to the fact that they are undetectable and cannot be attacked, regardless of the geographical situation of the machines in relation to the central server. The machines do not have to be “hidden” behind the central server, nor do they have to be situated on a common private network segment—they can be deployed anywhere: directly connected to the Internet throughout the World or installed on any LAN). This point is decisive for the securing device because several central servers can function without it being possible for an attacker to know where to find these central servers or to know the location of the machines working with these central servers because it is impossible to make the link between all of the machines due to the fact that they are not necessarily located on the same network segment.

This model is particularly adapted to telecommuting, whereby the employees of a firm are away on business or work from home. With the central server, they are immediately protected wherever they may be. In the same manner, an Internet access provider could protect all of its clients—thus saving them from having to install, configure and maintain security equipment which is expensive and frequently inefficient.

Email, inventory systems, online databases, user help applications and maintenance applications all pass by the central server which also permits the consolidation of the management of access rights, activity logs, alerts, and filters which are separately managed today by each application, this bringing with it the redundant costs and the risks, which have an increased effect, inherent to each application used.

With the technology of the central server, the problem of security is solved once and for all: there is no longer the need for security software deployed at each station, firewalls which are expensive, badly configured and bearing new loopholes and no longer the need for surveillance services or risks which are overlooked due to a lack of means or which are not identified. The generalised use of the technology of the central server within a workgroup would have a decisive impact on the reduction of costs due to the economies of scale achieved with regard to installation, configuration, maintenance and the actions requiring to be carried out on workstations because only an agent of some KB, which is capable of configuring itself and of updating remotely, is necessary instead of unwieldy and costly solutions which, despite disparate and redundant security measures, regularly present new security loopholes which constantly need to be corrected using the patches sold by the manufacturers of these systems which are recognised as being vulnerable.

The use of an agent which blocks all listening services and diverts the outgoing connections on all machines makes it possible to use the central server technology without having to modify the applications already in place. As it is possible to easily integrate switching devices using the central server technology within networks using conventional switches, the device according to the invention is able to be distributed progressively and at little cost.

Within the framework of the invention, it should be noted that several central servers can be concatenated to make them work with a tolerance of breakdowns, each of them being synchronised with its immediate neighbour at given time intervals in order to update the data of each central server. The synchronisation can, for example, have a hierarchical or serial connection diagram.

Several central servers can also be used with the aim of sharing the workload, with each of them sending connections to its immediate neighbour when it has reached its simultaneous connection limit (the number of threads of the group of threads of the central server which can be defined according to the processing capacity of each central server). The load share can for example adopt a hierarchical or serial connection diagram and can be combined with synchronisation of the database described hereafter.

Finally, several central servers can be synchronised with each other in real time so that, if one of the servers becomes unavailable, the client and server machines use the subsequent central server in their list of redundant servers, which list is supplied to them at the time of their connection to one of the central servers. This system can be used to share the load by distributing the client and server machines between several central servers before a breakdown occurs. This system is transparent for the users and requires no additional hardware means dedicated to load sharing.

In conclusion, the system according to the invention presents considerable advantages over existing systems. It is much easier and more economical to use, much safer and performs much better because it does not use intermediate components which involve format conversions and translations, with the sole aim of allowing them to interface in order to function together.

One of the essential advantages arises from the fact that client security is ensured because:
the clients and servers are invisible and cannot be attacked from the network because they no longer accept any connection,
the central server is able to carry out the sorting of the incoming connections because it only accepts users and machines which have been previously authorised by the central server to communicate amongst themselves,
the technology of the central server offers protection from any attack to all users connected to the central server.

Furthermore, the central server is less expensive to protect, install and maintain than any of the servers which it replaces because:
the technology of the central server allows it to be cloned and situated anywhere to redirect traffic from an infinite number of networks instead of having to be located at the intersection point of these same networks,
the technology of the central server authenticates the machines and users even before they have had the chance to carry out any activity—which allows connections coming from unknown sources to be rejected automatically without unnecessarily exposing the central server or its host,

the technology of the central server uses the most sophisticated methods currently available to encrypt and sign the connections while the majority of internet services use only plain text passwords and plain text data (SMTP, POP3, HTTP, FTP, LDAP, etc.) or encryption methods which have already shown serious vulnerabilities (search ‘SSL+vulnerability’ or ‘SSH+vulnerability’),
the redundant and load sharing architecture of the central server protects it from denial of service attacks because if a central server no longer responds, the clients automatically change central server without interruption of service without having to use expensive switching arrangements which are dedicated to load sharing or redundancy.

1. A data transmission system, comprising at least one data transmission network, one or more client machines linked to said network and one or more server machines which are also linked to said network, whereby each of said client machines is able to be connected at a given moment, via said central server, to one or more of said server machines in order to exchange data with it;
wherein
said server or client machines do not have means allowing them to receive incoming connections, but each of said server machines includes a client connection means device which allow it to establish a permanent connection with said central server and each of said client machines includes a client connection means device which allow it to establish a temporary connection with said central server, and
said central server includes a connection means device which allow the establishment of a bidirectional bridge in order to interconnect a client machine and a server machine with the aim of exchanging data, said bidirectional bridge including a unidirectional gateway which allows data transfer from said temporary connection to said permanent connection and a unidirectional gateway allowing data transfer from said permanent connection to said temporary connection, said gateways mutually self-destructing in a cascading manner if one of the connections is cut, which automatically terminates said bidirectional bridge.

2. The data transmission system according to claim 1, in which said central server connection device requests said client connection device of said server machine to establish a new permanent connection to said central server for each new bidirectional bridge created.

3. The system according to claim 1, in which said client connection device of each client machine are adapted in order to establish a permanent connection to said central server.

4. The system according to claim 1, in which said client connection device of a client machine establishes a temporary connection with the central server when said client machine wishes to exchange data with a server machine.

5. The system according to claim 1, in which said central server connection device includes a unidirectional broadcast device adapted for transmitting a message sent by a client machine to one or more server machines using said temporary connection device of the client machine and said permanent connection of each server machine.

6. The system according to claim 1, in which the connection devices of a client or server machine establish a connection to said central server to obtain a temporary connection to the central server when said client or server machine wishes to register at the central server or signal a change of status to the central server, said central server having a table of statuses stored in memory, allowing the recording of said registration or said change of status and notably the system identifier of the permanent connections, the name of a potential user and the MAC (Media Access Control) address of the client or server machines.

7. The system according to claim 6, in which said central server connection device is adapted to verify if the temporary registration connection or temporary status change connection signals an SOS coming from a server machine and, if this is the case, record said SOS stored in memory in an SOS table maintained by said central server then transmit said SOS to all of the online client machines which have the right to access said server machine.

8. The system according to claim 7, in which, following the receipt of a temporary status change connection or temporary SOS connection, said connection device of the central server is adapted to close the permanent connection between said client or server machine and said central server, which central server then saves said temporary connection as the new permanent connection for said client or server machine.

9. The system according to claim 1, in which said central server connection device includes a multicriteria search device which allows a client machine which has established a connection to said central server in order to obtain a temporary connection with the central server to locate one or more server machines having an operational permanent connection by using said permanent connection of each server machine to identify which server machines are online and said temporary connection of the client machine to retrieve the result of the search.

10. The system according to claim 1, in which said connection devices of the client or server machines include a device for periodically sending a packet (“keep alive”) to the central server to detect connection breaks and to re-establish a connection as soon as possible.

11. The system according to claim 1, comprising several central servers of the same redundant and load-sharing operating type.

12. The system according to claim 1, in which the central server can remotely carry out any necessary task on client or server machines in general and, in particular, can remotely proceed to automatically update the part of the application deployed on the client and server machines.

13. The system according to claim 1, in which said central server possesses a single network interface on which it transmits traffic to an infinite number of private networks connected to the Internet, regardless of the geographical situation of the central server in relation to these networks.
